(19) United States
(12) Patent Application Publication
(10) Pub. No.: US 2017/0305686 A1
(43) Pub. Date: Oct. 26, 2017

(54) UNLOADING STATION OF A CONVEYING DEVICE AND CONVEYING DEVICE

(71) Applicant: Dematic GmbH, Heusenstamm (DE)

(72) Inventor: Thomas Otto, Bielefeld (DE)

(21) Appl. No.: 15/493,642

(22) Filed: Apr. 21, 2017

(30) Foreign Application Priority Data
Apr. 22, 2016 (DE) 202016102162.6

(51) Int. Cl. B65G 47/82

(52) U.S. Cl. CPC B65G 47/82

(57) ABSTRACT

A discharging station of a conveyor for deposit tables disposed to be movable along a conveying path and having pushers which can move transversely to the movement direction of the deposit tables includes a frame, a rail arrangement having a first rail track and a second rail track extending in parallel therewith, along which the deposit tables are movably disposed, and a guide element disposed on the frame for guiding an entrainer of the pushers, with which the objects to be conveyed can be pushed down from the respective deposit table in the direction of at least one of the rail tracks. The guide element is fixed to the frame such that it can be lowered from an operational position into a decoupling position.

### CROSS REFERENCE TO RELATED APPLICATION

The present application claims priority of German Utility Model application Ser. No. 20 2016 102 162.6 filed Apr. 22, 2016.

### FIELD OF THE INVENTION

The present invention relates to a discharging station of a conveyor for deposit tables disposed to be movable along a conveying path and a conveyor for conveying objects.

Generic discharging stations and conveyors are known, for example, from DE 199 598 43 A1. They are used in particular in conveyors that serve to convey packets or other objects which lie on respective deposit tables and are transported, lying on the deposit tables, along a conveying path to a discharging station. As soon as the discharging station is reached, a pusher which can move perpendicularly to the conveying direction on the respective deposit tables serves to push the object to be conveyed down from the deposit table onto a slide, a further conveying path or the like.

In the event of either an object being pushed off the deposit table by the pusher or of the pusher itself becoming jammed in these types of conveyors, the conveyor must be stopped and the jam rectified. This is rendered particularly difficult by the fact that, owing to the cooperation of a first guide element attached to the pusher with a second guide element attached to the frame of the discharging station, for example, in the form of a curved track, the pusher can be released from its position displaced towards the output station only with a great deal of effort. For this purpose, it is particularly necessary for the first guide element to be detached from the pusher or for the second guide element to be detached from the frame. Moreover, such detachment is very time-consuming and greatly delays the conveyance of the objects to be conveyed.

### SUMMARY OF THE INVENTION

The present invention provides a discharging station for deposit tables disposed to be movable along a conveying path, and a conveyor with which a jamming situation can be dealt with easily and quickly.

In accordance with an aspect of the invention, the discharging station has a frame, a rail arrangement with a first rail track and a second rail track extending in parallel therewith, along which the deposit tables are movably disposed, and a guide element disposed on the frame for guiding an entrainer of the pushers with which the objects to be conveyed can be pushed down from the respective deposit table in the direction of at least one of the rail tracks. A guide element is fixed to the frame in such a way that it can be lowered from an operational position in which the guide elements cooperate with each other into a decoupling position in which the guide elements are separated from each other. Due to the fact that the noted guide element can be lowered, it becomes possible for the pusher to be pushed back easily in the event of one of the objects to be conveyed becoming solidly jammed, since the guide element of the pusher is out of engagement with the guide element of the frame. The jammed object can thus be exposed and taken away from the deposit table.

The noted guide element, which may be referred to as a second guide element, can then be raised back into its operational position so that the conveyance of the objects along the conveying path can be resumed within a short time.

According to a particular embodiment variant, the second guide element is fixed to the frame to be pivotable about a rotary spindle extending in parallel with the longitudinal direction of the rail tracks. A support unit pivotably fastened to the frame supports the second guide element in a first support position in the operational position and in a second support position in the decoupling position lowered relative to the operational position. The pivotable attachment of the second guide element to the frame makes possible sufficient lowering of the second guide element, which at the same time allows easily effected coupling and decoupling of the guide elements.

According to a further embodiment variant, the support unit comprises a support element fixed to the frame to be pivotable about a rotary spindle which extends in parallel with the longitudinal direction of the rail tracks, and lying against the second guide element, and comprises a control unit connected to the support element for displacement of the support element. The control unit thus permits displacement of the support element to be effected easily.

In one embodiment variant, the control unit is manually displaceable and in another variant it is designed to be driven by a motor. According to one preferred embodiment variant, the control unit comprises a drive rod which is pivotably fastened to the frame and coupled to the support element. The drive rod may be configured as a telescopic rod.

According to yet another embodiment variant, the second guide element is designed as a guide web fastened to a plate, along which guide web the entrainer, such as configured as a control wheel, can be guided in such a way that the pusher of a respective deposit table is pushed towards a discharging edge of the deposit table.

The conveyor for conveying objects comprises a rail arrangement with a frame, a first rail track and a second rail track extending in parallel therewith, along which second rail track at least one deposit table can move, and on which an object to be conveyed can be laid. The deposit table is thus mounted on the rail arrangement in a sliding or rolling manner. The deposit table comprises a pusher which can move transversely to the movement direction of the deposit table and with which the object to be conveyed can be pushed down from the deposit table.

An entrainer is fixed on an underside of the pusher and can be coupled to a guide element disposed on the frame in the region of a discharging station. The guide element is thus fixed to the frame to be displaceable away from the deposit table perpendicularly with respect to the movement direction of the deposit table and perpendicularly with respect to the movement direction of the pusher out of a first working position coupled to the entrainer into a decoupling position decoupled from the entrainer.

With the aid of the attached drawings, these and other objects, advantages, purposes and features of this invention will become apparent upon review of the exemplified embodiments that are explained in more detail in the following specification.

### BRIEF DESCRIPTION OF THE DRAWINGS

FIG. 1 shows a perspective view of an embodiment variant of a discharging station in accordance with the invention;

FIG. 2 shows a partial exploded view of the discharging station shown in FIG. 1;

FIG. 3 shows a side view of the discharging station and of a deposit table in the operational position with a pusher advanced into the discharging position;

FIG. 4 shows a side view of the discharging station shown in FIG. 3 and of the deposit table with a pusher advanced into the discharging position with a lowered guide element decoupled from the entrainer; and

FIG. 5 shows a side view of an alternative embodiment variant of a guide element and a support unit and control unit coupled thereto.

### DESCRIPTION OF THE PREFERRED EMBODIMENTS

In the following description of the figures, terms such as top, bottom, left, right, front, rear, etc. relate exclusively to the example representation and position, selected in the respective figures, of the discharging station, of the frame, of the pusher, of the deposit table, of the entrainer, of the guide element and the like. These terms are not to be understood to be limiting, i.e. these references can change by virtue of different working positions or the mirror-symmetrical arrangement or the like.

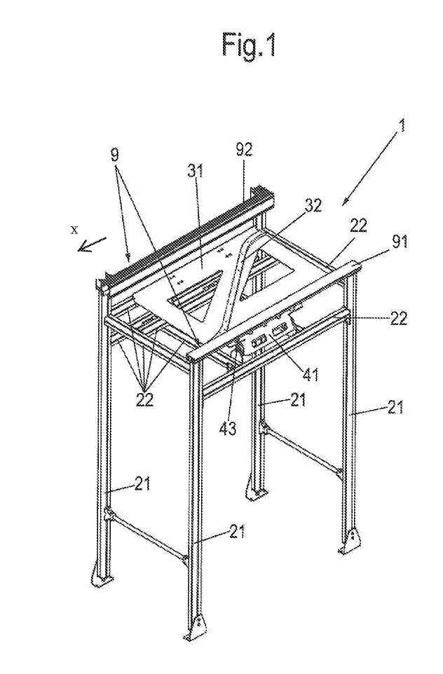

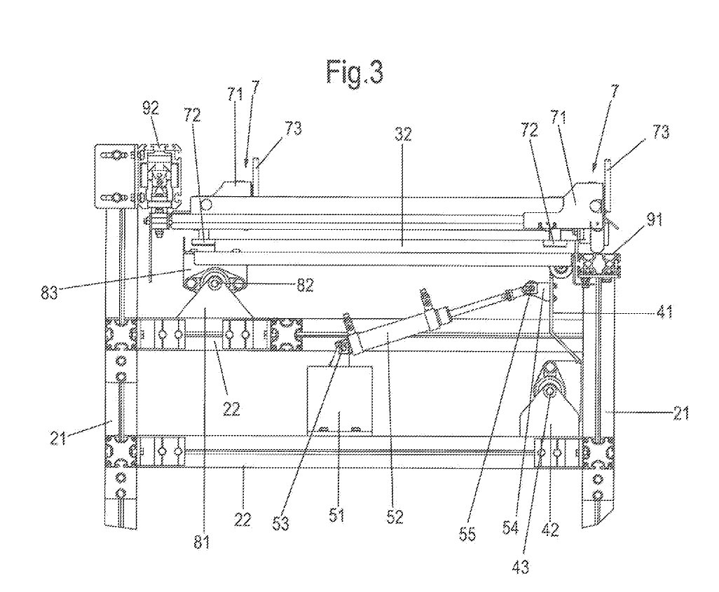

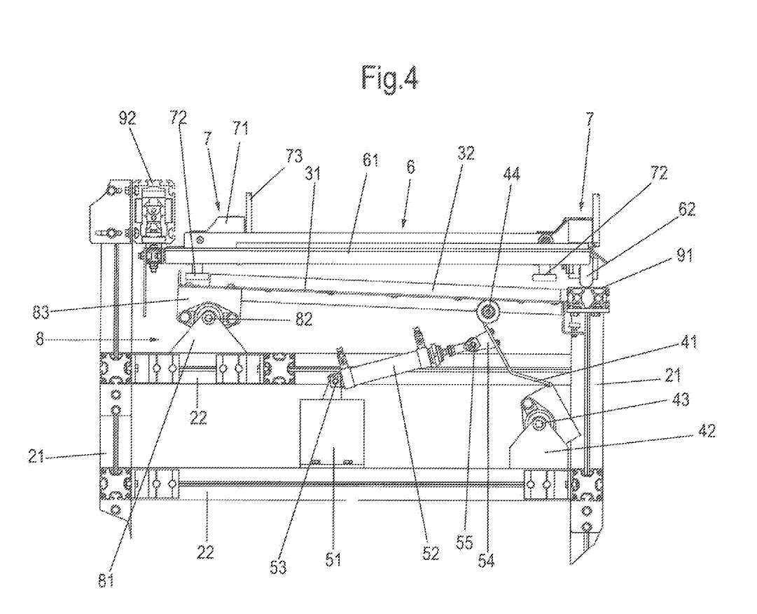

In the illustrated embodiment of FIG. 1, the reference sign 1 designates as a whole an embodiment variant of a discharging station in accordance with aspects of the present invention. The discharging station 1 is thus a component of a conveyor for conveying objects which lie on respective deposit tables 6 of the conveyor and are transported on the deposit tables 6 along a conveying path from a passing station to the discharging station 1. The discharging station 1 thus comprises a frame 2 which is preferably constructed from a metal rod arrangement with a plurality of standing legs 21 and transverse struts 22. A rail arrangement 9 with a first rail track 91 and a second rail track 92 extending in parallel therewith are fastened to the frame 2 and form a partial section of the conveying path along which the deposit tables 6 can be moved. As shown in FIGS. 3 and 4, each of the deposit tables 6 comprises a deposit surface 61 on which the objects to be conveyed can be laid.

Furthermore, a pusher 7, which can move perpendicularly to the movement direction x of the deposit table 6, is displaceably fixed to each of the deposit tables 6, with which pusher the object to be conveyed can be pushed off the deposit table 6 via a side edge—which extends in parallel with the rail tracks 91, 92—of the deposit table 6 onto a slide, a further conveying path or the like. The pusher 7 thus comprises a thrust plate 73 extending preferably perpendicularly to the support surface 61 of the deposit table 6 and in parallel with the rail tracks 91, 92 and being fixed to a pusher housing 71. The pusher housing 71 extends preferably in a u-shaped manner about the deposit table 6.

An entrainer 72, which in the illustrated embodiment is designed as a control wheel which can rotate about a vertical rotary spindle is fixed on an underside of the pusher 7. As soon as the deposit table 6 reaches the discharging station 1, this entrainer 72 is guided by a guide element 3, which is fastened to the frame 2, from a loading position into a push-off position close to the previously mentioned edge of the deposit table 6, as is the pusher 7 therewith, so that, when travelling over a deposit table 6 of the discharging station 1, the pusher 7 pushes the object deposited on the deposit table 6 down from the support surface 61 of the deposit table 6 in the direction of the rail track 91 and off the deposit table 6.

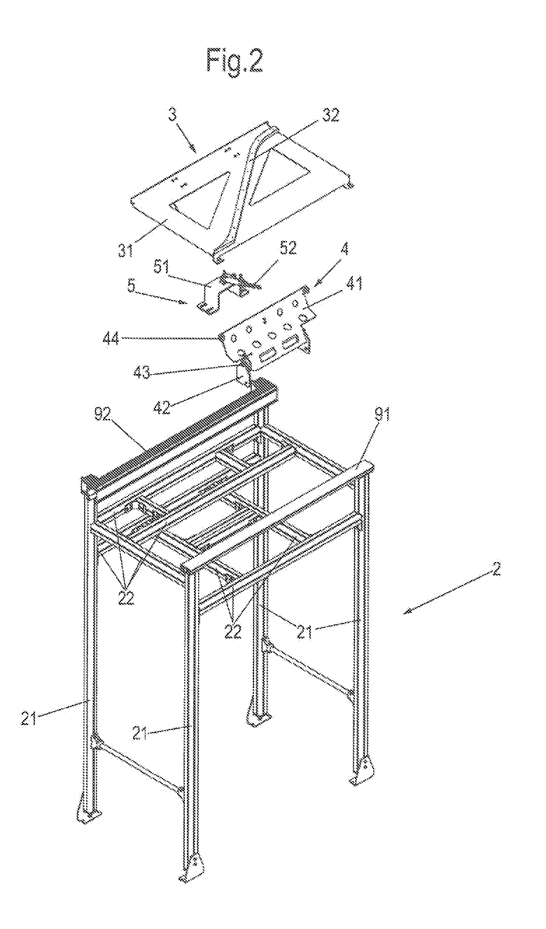

One embodiment variant of such a guide element 3 is illustrated in FIGS. 1-4. The guide element 3, as clearly shown in FIG. 2, consists of a plate 31, on the upper side of which facing the deposit table 6, a guide web 32 extending approximately diagonally over the plate 31 is attached. It is also feasible to form the guide web 32 as an S-shaped curve or the like.

As shown in FIGS. 3 and 4, the guide element 3 is fastened, in a region below the second rail track 92, to be pivotable by means of a hinge 8 with a holder 81 on a transverse support 22 of the frame 2 about a rotary spindle 82 extending in parallel with the longitudinal direction of the rail tracks 91, 92, so that the guide element 3, in an operational position shown in FIG. 3, is oriented in parallel with the displacement direction of the entrainer 72 of the pusher 7 so that the entrainer 72 of a pusher 7 of a deposit table 6 moving along the discharging station 1 is always in contact with the guide element 3.

In order to release the coupling of the entrainer 72 of the pusher 7 to the guide element 3 when necessary, the guide element 3 is fixed to the frame 2 in such a way that it can be lowered from the operational position into a decoupling position. For this purpose, in the illustrated embodiment, the guide element 3 is supported in a region below the first rail track 91 by a support unit 4. As understood from FIG. 2, the support unit 4 comprises a support element 41 designed as a flat sheet metal part and fixed to the frame 2 via a pivot part 42 about a rotary spindle 43 extending in parallel with the longitudinal direction of the rail tracks 91, 92. The support element 41 thus lies against the second guide element 3 when the support unit 4 is in the installed state.

In order to lower the guide element 3, the support unit 4 is connected to a control unit 5 for displacement of the support element 41. The control unit 5 thus consists substantially of a drive rod 52 which is pivotably fastened to the frame 2 and is coupled to the support element 41. The drive rod 52 can thus pivot on the one hand via a support foot 51 on the frame 2 about a rotary spindle 53 extending in parallel with the longitudinal direction of the rail tracks 91, 92. In one preferred embodiment, the drive rod 52 is designed as a telescopic rod so that, depending on the attachment location of the control unit 5 to the frame 2, a change in length of the drive rod 52 permitting pivoting of the support element 41 is rendered possible. The control unit 5, in particular the drive rod 52, is designed to be driven by a motor. However, manual displaceability of the control unit 5 may alternatively be employed.

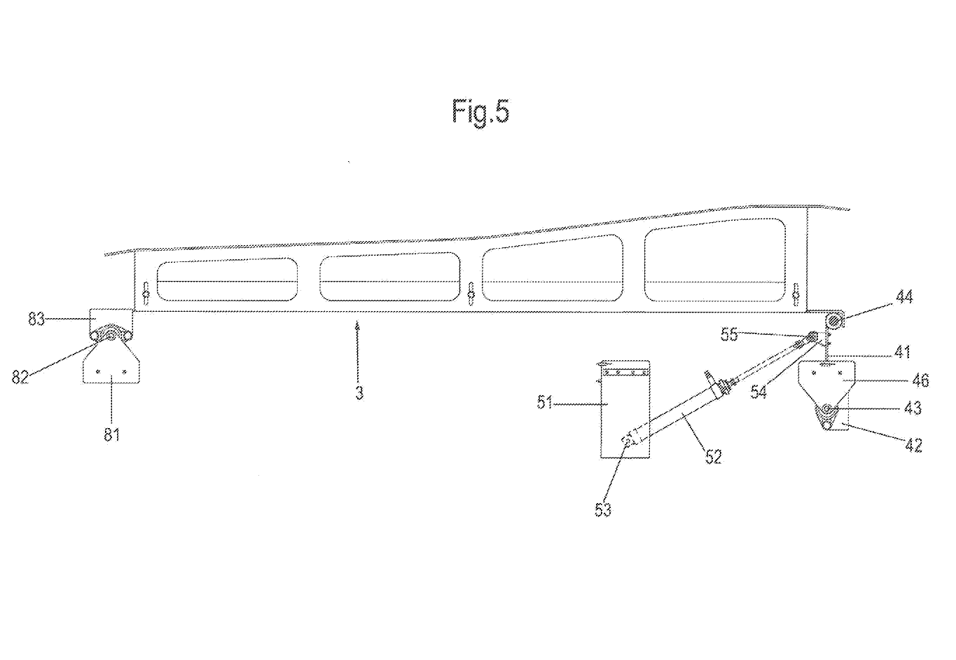

Referring now to FIG. 5, an alternative embodiment variant of a guide element 3 is disclosed. In this case, in particular, the attachment of the support unit 4 and of the control unit 5 is achieved in an alternative way. A fastening head 54 is attached to the drive rod 52 and is coupled to the support element 41. The rotary hinge 46 of the support unit 4 is in this case arranged in such a way that the plate 31 of the guide element 3 lies in the lowered position on a transverse bar 22 of the frame 2.

Of note is that in the region of the front edge of the deposit table 6, in which the pusher 7 is advanced in the direction of the push-off position, the guide element 3 can be lowered sufficiently to decouple the guide element 3 from the entrainer 72.

It should be appreciated that a discharging station 1 with two guide elements disposed next to each other in the displacement direction of the pushers 7 is also feasible, wherein, depending on the manner of control, the pusher 7 can be displaced in the direction of the first rail track 91 or the second rail track 92. In this case, the discharging station 1 correspondingly comprises two guide elements disposed next to each other in the displacement direction of the pusher 2, which guide elements are pivotably fixed midway between the rail tracks 91, 92 and can be lowered in a corresponding manner in the region of the rail tracks 91, 92 in order to permit decoupling of the entrainer 72 of the pusher 7 or of the entrainers of the pushers in the case of two pushers disposed on the deposit table 6.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A discharging station of a conveyor for deposit tables disposed to be movable along a conveying path and having pushers which can move transversely to the movement direction of the deposit tables, comprising
a frame;
a rail arrangement having a first rail track and a second rail track extending in parallel therewith, along which the deposit tables are movably disposed;
a guide element disposed on the frame for guiding an entrainer of the pushers, with which the objects to be conveyed can be pushed down from the respective deposit table in the direction of at least one of the rail tracks;
wherein the guide element is fixed to the frame in such that it can be lowered from an operational position into a decoupling position.

2. The discharging station as claimed in claim 1, wherein the guide element is fixed to the frame to be pivotable about a rotary spindle extending in parallel with the longitudinal direction of the rail tracks, and wherein a support unit pivotably fastened to frame supports the guide element in a first support position in the operational position and in a second support position in the decoupling position lowered relative to the operational position.

3. The discharging station as claimed in claim 2, wherein the support unit comprises a support element fixed to the frame to be pivotable about a rotary spindle which extends in parallel with the longitudinal direction of the rail tracks and lying against the guide element, and comprises a control unit connected to the support element for displacement of the support element.

4. The discharging station as claimed in claim 3, wherein the control unit comprises a drive rod which is pivotably fastened to the frame and is coupled to the support element.

5. The discharging station as claimed in claim 4, wherein the drive rod is designed as a telescopic rod.

6. The discharging station as claimed in claim 5, wherein the control unit is designed to be driven by a motor.

7. The discharging station as claimed in claim 6, wherein at least one slide roller lying against the guide element is attached to a front edge of the support element close to the guide element.

8. The discharging station as claimed in claim 1, wherein the guide element is designed as a guide web fastened to a plate.

9. The discharging station as claimed in claim 3, wherein the control unit is designed to be driven by a motor.

10. The discharging station as claimed in claim 3, wherein at least one slide roller lying against the guide element is attached to a front edge of the support element close to the guide element.

11. The discharging station as claimed in claim 2, wherein the guide element is designed as a guide web fastened to a plate.

12. A conveyor for conveying objects, comprising
a rail arrangement with a frame, a first rail track and a second rail track extending in parallel therewith, along which second rail track at least one deposit table can move, on which an object to be conveyed can be laid;
wherein the deposit table is mounted on the rail arrangement in a sliding or rolling manner;
wherein the deposit table comprises a pusher which can move transversely to the movement direction of the deposit table and with which the object to be conveyed can be pushed down from the deposit table;
wherein an entrainer is fixed on the underside of the pusher and can be coupled to a guide element disposed on the frame in the region of a discharging station;
wherein the guide element is fixed to the frame to be displaceable away from the deposit table perpendicularly to the movement direction of the deposit table and perpendicularly to the movement direction of the pusher out of a first working position coupled to the entrainer into a decoupling position decoupled from the entrainer.
